(19) United States
(12) Patent Application Publication
(10) Pub. No.: US 2026/0302427 A1
(43) Pub. Date: Oct. 1, 2026

(54) HEAT INSULATING SHEET FOR HEAT INSULATION BETWEEN BATTERY CELLS FOR ELECTRIC VEHICLE

(71) Applicant: SUMITOMO RIKO COMPANY LIMITED, Aichi (JP)

(72) Inventors: Shota HAYASHI, Aichi (JP); Shinji KUMAGAI, Aichi (JP); Natsuki YAMAOKA, Aichi (JP)

(73) Assignee: SUMITOMO RIKO COMPANY LIMITED, Aichi (JP)

(21) Appl. No.: 19/328,949

(22) Filed: Sep. 15, 2025

(30) Foreign Application Priority Data
Mar. 28, 2025 (WO) PCT/JP2025/012703
May 26, 2025 (JP) 2025-087031
Jul. 11, 2025 (JP) 2025-116927

(51) Int. Cl. H01M 10/658; H01M 10/6555

(52) U.S. Cl. CPC H01M 10/658; H01M 10/6555; H01M 2220/20

(57) ABSTRACT

A heat insulating sheet includes used for heat insulation between battery cells of an electric vehicle a silica aerogel, fibers, and infrared ray shielding particles. In a photograph of a cross section of the sheet, first particles composed of the infrared ray shielding particles each having a major axis length of 0.5 μm to 1 μm and second particles composed of the infrared ray shielding particles each having a major axis length of 5 μm to 10 μm are present. In the photograph, a ratio of a number of the first particles to a number of the second particles is 1:4 to 3:1, and a sum of a percentage of the number of the first particles and a percentage of the number of the second particles in the infrared ray shielding particles each having a major axis length of 0.5 μm to 10 μm is 20% to 30%.

### CROSS-REFERENCE

This application claims priority to Japanese Patent Application No. 2025-116927, filed on Jul. 11, 2025, which itself claims priority to International Patent Application No. PCT/JP2025/012703, filed on Mar. 28, 2025, and Japanese Patent Application No. 2025-087031 filed on May 26, 2025, which is a divisional application of Japanese Patent Application No. 2025-518773 filed on Mar. 31, 2025, as a National Stage of International Application No. PCT/JP2025/012703, filed on Mar. 28, 2025. The contents of each of the above applications are fully incorporated herein by reference.

### BACKGROUND

### 1. Technical Field

The present disclosure relates to a heat insulating sheet used for heat insulation between battery cells of an electric vehicle, and a method for producing the same.

### 2. Description of Related Art

A silica aerogel has a porous structure including pores each having a pore diameter smaller than the mean free path of air, and a skeleton of the silica aerogel is formed by a plurality of silica fine particles connected together. Due to this fine porous structure, the silica aerogel has a low thermal conductivity, and is useful as a component of a heat insulating material in in-vehicle components, residential building materials, industrial equipment, and the like.

On the other hand, a heat insulating material containing silica aerogel often has a low mechanical strength of the surface. Therefore, there is a problem that when an external force is applied to the heat insulating material, a phenomenon called powder shedding, in which powder composed of a constituent substance of the heat insulating material falls off from the heat insulating material, tends to occur. For example, in a heat insulating material used for heat insulation between battery cells of an electric vehicle, repeated loads caused by battery expansion due to heat or charging are applied. In addition, in a heat insulating material for an automobile, vibration generated during driving of an automobile is applied. Therefore, when a sheet containing silica aerogel is used as the heat insulating material for the automobile battery, the powder shedding from the sheet may occur due to the above-described loads and vibration, possibly leading to a deterioration in heat insulating performance.

In addition, the powder shedding tends to occur easily on portions of the sheet surface that receives stress accompanying battery expansion or on portions located near sources of vibration. Therefore, when powder shedding occurs, an uneven distribution of the composition in the heat insulating material may occur, and a portion having a low heat insulating performance may be formed in a part of the heat insulating material.

Therefore, as a technique for suppressing the occurrence of the powder shedding, for example, JP 2023-132944 A discloses a technique of blending a hot-melt powder into the sheet containing silica aerogel, a technique of sealing the surface of the sheet with a film, and the like. In addition, JP 2023-35097 A discloses a technique in which a heat insulation elastic member including an elastic layer is provided on one surface of a silica aerogel sheet, and a cover layer is provided on the other surface, or the sheet and the entire assembly are covered with an exterior body.

### SUMMARY

However, when a sheet containing silica aerogel is covered with a film or the like, external forces are repeatedly applied to the heat insulating material during long-term use, which leads to peeling off the film from the sheet and shedding the powder. In particular, when the sheet contains a substance having relatively high specific gravity such as silicon carbide, there is a problem that the substance having the high specific gravity is likely to fall off from the sheet, which may result in deterioration of the heat insulating performance. According to the technique disclosed in JP 2023-132944 A, the cured layer formed by the hot-melt powder may deteriorate the heat insulating performance of the sheet.

The present disclosure has been made in view of such a background, and it is an object of the present disclosure to provide a heat insulating sheet between battery cells for an electric vehicle, which can maintain a good heat insulating performance over a long period of time, and a method for producing the same.

One aspect of the present disclosure is a heat insulating sheet for heat insulation between battery cells of an electric vehicle, the sheet including:
a silica aerogel;
fibers; and
infrared ray shielding particles, wherein
second particles composed of the infrared ray shielding particles each having a major axis length of 5 μm or more and 10 μm or less are present in a photograph obtained by observing a cross section of the sheet, and
in the photograph, a percentage of a number of the second particles in the infrared ray shielding particles each having a major axis length of 0.5 μm or more and 10 μm or less is 4% or more and 30% or less.

Another aspect of the present disclosure is a method for producing the heat insulating sheet according to the above-described aspect, the method including:
preparing a sheet precursor in which the fibers are impregnated with a wet gel containing silica fine particles and the infrared ray shielding particles dispersed in the wet gel; and
drying the wet gel in the sheet precursor to form the heat insulating sheet.

The heat insulating sheet between battery cells for an electric vehicle (hereinafter, referred to as a “heat insulating sheet”) includes silica aerogel, fibers, and infrared ray shielding particles. The infrared ray shielding particles contain the second particles each having the specific major axis length and being present at the specific proportion. The infrared ray shielding particles serve to enhance heat insulating performance by blocking radiant heat. It is known that the effect of blocking the radiant heat by the infrared ray shielding particle increases as the particle size of the infrared ray shielding particle increases. On the other hand, when the particle size of the infrared ray shielding particle increases, the infrared ray shielding particles tend to become interconnected in the heat insulating sheet. As a result, a heat transfer path including the infrared ray shiel ding particles is easily formed, which may reduce the heat insulating performance. For this reason, in conventional heat insulating sheet of this type, infrared ray shielding particles each having a particle size of a predetermined value or less and a small variation in the particle size have been used, in order to enhance the radiant heat blocking effect while avoiding the interconnection of the infrared ray shielding particles.

In contrast to such common technical knowledge, the intentional use of infrared ray shielding particles containing the second particles makes it possible to suppress the shedding of the second particles from the heat insulating sheet even when external forces or vibration are applied to the heat insulating sheet. The second particles are retained in the heat insulating sheet over a long period of time, thereby maintaining a good heat insulating performance of the heat insulating sheet over a long period of time.

Therefore, according to the above aspects, it is possible to provide the heat insulating sheet that can maintain a good heat insulating performance over a long period of time, and a method for producing the same.

### BRIEF DESCRIPTION OF THE DRAWINGS

FIG. 1 is a cross-sectional view schematically showing a cross section of a heat insulating sheet parallel to a thickness direction.

### DETAILED DESCRIPTION OF PREFERRED EMBODIMENTS

### (Heat Insulating Sheet)

A configuration of the heat insulating sheet will be described below.

### [Silica Aerogel]

The silica aerogel is composed of silica fine particles and is a porous structure including pores. Most of the pores in the silica aerogel are usually mesopores having a diameter of 50 nm or less. Since the pore diameter of the mesopore is smaller than the mean free path of air, convection of air in the pores can be suppressed by using the silica aerogel. As a result, heat transfer due to convection can be suppressed, and the heat insulating performance can be improved. The lower limit of the diameter of the pore is not particularly limited from the viewpoint of suppressing convection of air in the pores, but the diameter of the pore is preferably, for example, 10 nm or more.

A skeleton of the silica aerogel is mainly composed of secondary particles formed by aggregation of the silica fine particles as primary particles. The average particle diameter of the silica fine particles (primary particle) is usually from about 2 nm to about 5 nm. The average particle diameter of the silica fine particle can be measured by electron microscope observation.

The average particle diameter of particles (mainly secondary particles) constituting the skeleton of the silica aerogel is preferably 1 μm or more, and more preferably 10 μm or more. The upper limit of the average particle diameter of the particle constituting the skeleton is not particularly limited from the viewpoint of improving the heat insulating performance, but the average particle diameter of the particle constituting the skeleton is preferably, for example, 200 μm or less. The average particle diameter of the particle constituting the skeleton is a median diameter (that is, D50) obtained from a volume-based particle size distribution measured by a laser diffraction/scattering method.

The content of the silica aerogel in the heat insulating sheet is preferably 10 mass % or more, more preferably 20 mass % or more, and still more preferably 30 mass % or more. In this case, the effect of improving the heat insulating performance by the silica aerogel can be more reliably obtained.

On the other hand, the content of the silica aerogel in the heat insulating sheet is preferably 60 mass % or less, more preferably 50 mass % or less, and still more preferably 40 mass % or less. In this case, a decrease in the mechanical strength of the heat insulating sheet can be more easily avoided. As a result, the powder shedding from the heat insulating sheet can be made less likely to occur.

In configuring a preferable range of the content of the silica aerogel, the upper limit and the lower limit of the content of the silica aerogel described above can be arbitrarily combined. For example, a preferable range of the content of the silica aerogel in the heat insulating sheet may be 10 mass % or more and 60 mass % or less, 20 mass % or more and 50 mass % or less, or 30 mass % or more and 40 mass % or less.

The silica aerogel can be obtained, for example, by gelating a sol containing the silica fine particles and a liquid dispersion medium for dispersing the silica fine particles, and then drying the resulting gel to remove the liquid dispersion medium from the gel. The method for drying the gel is not particularly limited. The drying can be performed, for example, in an atmosphere at a normal pressure or in a supercritical fluid. The gel can also be dried by freeze drying or drying under an environmental pressure.

A gel obtained by performing drying in the atmosphere at a normal pressure may be referred to as a “xerogel”, a gel obtained by performing drying in a supercritical fluid may be referred to as an “aerogel”, a gel obtained by freeze drying may be referred to as a “cryogel”, and a gel obtained by performing drying under the environmental pressure may be referred to as an “ambigel”. The silica aerogel contained in the heat insulating sheet may be manufactured by any method. That is, the “silica aerogel” in the present specification includes the “aerogel”, the “xerogel”, the “cryogel”, and the “ambigel” each composed of the silica fine particles.

The silica aerogel may be subjected to a hydrophobic treatment in its preparation process. When the hydrophobic treatment of the gel is performed before a drying step, drying in a supercritical fluid becomes unnecessary, and the gel can be dried in the atmosphere at a normal pressure. Therefore, in this case, the preparation process of the silica aerogel can be further simplified, and the preparation cost can be further reduced.

### [Infrared Ray Shielding Particles]

The infrared ray shielding particles have a function of absorbing heat from the heat source and re-emitting the heat from a surface that faces the heat source, and a function of scattering infrared rays. Therefore, by blending the infrared ray shielding particles into the heat insulating sheet, the radiant heat from the heat source can be blocked, and the heat insulating performance can be improved, particularly at a high temperature.

A photograph obtained by observing a cross section of the heat insulating sheet contains at least the second particles composed of infrared ray shielding particles each having a major axis length of 5 μm or more and 10 μm or less. In the photograph, a percentage of the number of the second particles to the infrared ray shielding particles each having a major axis length of 0.5 μm or more and 10 μm or less is 4% or more and 30% or less. By using the infrared ray shielding particles in which the second particles having the specific percentage are contained in the photograph of the cross section of the heat insulating sheet, the heat insulating sheet can maintain a good heat insulating performance over a long period of time.

As a reason why the above-described effect can be achieved by the second particles, for example, the following reason can be considered. Since the second particles have a relatively large particle diameter, the second particles are considered to be easily captured by the fibers or the like when vibration, repeated loads, or the like are applied to the heat insulating sheet, causing the second particles to fall downward from their initial positions.

Therefore, by using the infrared ray shielding particles such that the second particles appear in the photograph of the cross section of the heat insulating sheet, it is considered that the powder shedding of the second particles is less likely to occur even when vibration, repeated loads, or the like are applied to the heat insulating sheet. It is considered that the second particles are retained in the heat insulating sheet over a long period of time, so that the heat insulating performance can be maintained.

From the viewpoint of further reducing the powder shedding, the percentage of the number of the second particles in the photograph is preferably 5% or more, more preferably 8% or more, still more preferably 10% or more, still more preferably 13% or more, and particularly preferably 15% or more.

On the other hand, in the photograph, by setting the percentage of the number of the second particles to the infrared ray shielding particles each having a major axis length of 0.5 μm or more and 10 μm or less to 30% or less, connection of the second particles to other infrared ray shielding particles in the heat insulating sheet can be easily avoided. As a result, the heat insulating performance of the heat insulating sheet can be enhanced. From the viewpoint of more reliably achieving such an effect, the percentage of the number of the second particles in the photograph is preferably 29% or less, 25% or less, 19% or less, less than 19%, 18% or less, 15% or less, 12% or less, 10% or less, less than 10%, or 8% or less.

In configuring a preferable range of the percentage of the number of the second particles in the photograph, the upper limit and the lower limit of the percentage of the number of the second particles described above can be arbitrarily combined. For example, a preferable range of the percentage of the number of the second particles in the photograph may be 4% or more and 29% or less, 5% or more and 25% or less, 4% or more and 19% or less, 4% or more and less than 19%, 5% or more and 18% or less, 5% or more and 15% or less, 5% or more and 12% or less, 5% or more and 10% or less, 5% or more and less than 10%, 5% or more and 8% or less, 8% or more and 30% or less, 10% or more and 25% or less, 10% or more and less than 19%, or 15% or more and 18% or less.

The heat insulating sheet may contain, in addition to the second particles, infrared ray shielding particles each having a major axis length outside the range described above in the photograph. Examples of the infrared ray shielding particles other than the second particles include first particles each having a major axis length of 0.5 μm or more and 1 μm or less in the photograph. Since the first particles have a relatively small particle size, the mass of each of the particles is small, and a percentage of the area to the mass is large. Therefore, it is considered that the first particles are less likely to fall downward from their initial positions even when vibration, repeated loads, or the like are applied to the heat insulating sheet. Accordingly, it is considered that by using the infrared ray shielding particles such that both the first particles and the second particles appear in the photograph of the cross section of the heat insulating sheet, the heat insulating performance can be maintained over a long period of time.

From the viewpoint of further reducing the powder shedding, the percentage of the number of the first particles in the photograph is preferably 1% or more, 3% or more, 5% or more, 8% or more, or 10% or more.

On the other hand, the percentage of the number of the first particles in the photograph is preferably 26% or less, 25% or less, 20% or less, 16% or less, less than 16%, or 14% or less. In this case, the heat insulating performance of the heat insulating sheet can be more easily improved.

In configuring a preferable range of the percentage of the number of the first particles in the photograph, the upper limit and the lower limit of the percentage of the number of the first particles described above can be arbitrarily combined. For example, the preferable range of the percentage of the number of the first particles in the photograph may be 1% or more and 26% or less, 1% or more and 25% or less, 1% or more and 20% or less, 1% or more and 16% or less, 1% or more and less than 16%, 1% or more and 14% or less, 3% or more and 26% or less, 5% or more and 14% or less, 8% or more and 14% or less, or 10% or more and 14% or less.

From the viewpoint of allowing the first particles and the second particles to act synergistically and more reliably achieve the effect of maintaining the heat insulating performance over a long period of time, the percentage of the number of the first particles to the number of the second particles each present in the photograph is preferably first particles:second particles=1:4 to 4:1, preferably from 1:4 to 3:1, more preferably from 1:4 to 2:1, and still more preferably from 1:4 to 1:1.

In the photograph, the sum of the percentage of the number of the first particles and the percentage of the number of the second particles in the infrared ray shielding particles each having a major axis length of 0.5 μm or more and 10 μm or less is preferably 5% or more, 10% or more, 15% or more, or 20% or more. In this case, the powder shedding of the first particles and the second particles from the heat insulating sheet can be further reduced. As a result, it is considered that the heat insulating performance of the heat insulating sheet can be maintained over a long period of time.

On the other hand, the sum of the percentage of the number of the first particles and the percentage of the number of the second particles in the photograph is preferably 30% or less, 25% or less, 20% or less, less than 20%, or 18% or less. In this case, the heat insulating performance of the heat insulating sheet can be more easily improved.

In configuring a preferable range of the sum of the percentage of the number of the first particles and the percentage of the number of the second particles in the photograph, the upper limit and the lower limit of the sum described above can be arbitrarily combined. For example, the preferable range of the sum of the percentage of the number of the first particles and the percentage of the number of the second particles in the photograph may be 5% or more and 30% or less, 10% or more and 30% or less, 15% or more and 30% or less, 20% or more and 30% or less, 5% or more and 25% or less, 5% or more and 20% or less, 5% or more and less than 20%, or 5% or more and 18% or less.

From the viewpoint of more reliably achieving the effects of the first particles and the second particles, in the photograph, the percentage of the number of the first particles is preferably 1% or more and 20% or less, and the percentage of the number of the second particles is preferably 4% or more and 29% or less. From the same viewpoint, in the photograph, the percentage of the number of the first particles is more preferably 3% or more and 15% or less, and the percentage of the number of the second particles is more preferably 5% or more and 25% or less.

It is preferable that the infrared ray shielding particles appearing in the photograph of the cross section of the heat insulating sheet further include third particles each having a major axis length of more than 1 μm and less than 5 μm. Since the third particle has a moderately large particle size, the third particle has high performance of blocking the radiant heat from the heat source. In addition, since the third particles are less likely to connect with each other in the heat insulating sheet, formation of a heat transfer path including the third particles can be easily avoided. Therefore, by using the infrared ray shielding particles in which the third particles appear in the photograph of the cross section of the heat insulating sheet, the initial heat insulating performance of the heat insulating sheet can be further enhanced. From the viewpoint of more reliably achieving such an effect, the percentage of the number of the third particles to the infrared ray shielding particles each having a major axis length of 0.5 μm or more and 10 μm or less in the photograph is preferably 70% or more, 75% or more, 80% or more, more than 80%, 82% or more, 85% or more, 90% or more, more than 90%, or 92% or more.

In addition, from the viewpoint of sufficiently increasing the percentage of the number of the second particles in the photograph to more reliably achieve the effect of suppressing the powder shedding, the percentage of the number of the third particles in the infrared ray shielding particles each having a major axis length of 0.5 μm or more and 10 μm or less in the photograph is preferably 96% or less, 95% or less, 92% or less, 90% or less, or 85% or less.

In configuring a preferable range of the percentage of the number of the third particles, the upper limit and the lower limit of the percentage of the number of the third particles described above can be arbitrarily combined. For example, a preferable range of the percentage of the number of the third particles among the infrared ray shielding particles each having a major axis length of 0.5 μm or more and 10 μm or less in the photograph may be 70% or more and 96% or less, 75% or more and 96% or less, 80% or more and 96% or less, more than 80% and 96% or less, 82% or more and 96% or less, 85% or more and 96% or less, 90% or more and 96% or less, more than 90% and 96% or less, 92% or more and 96% or less, 70% or more and 95% or less, 70% or more and 92% or less, 75% or more and 90% or less, 80% or more and 95% or less, more than 80% and 95% or less, or 82% or more and 95% or less.

From the viewpoint of more reliably achieving the effects of the second particles and the third particles, in the photograph, among the infrared ray shielding particles each having a major axis length of 0.5 μm or more and 10 μm or less, the percentage of the number of the second particles is preferably 5% or more and 25% or less, and the percentage of the number of the third particles is preferably 75% or more and 95% or less. From the same viewpoint, in the photograph, among the infrared ray shielding particles each having a major axis length of 0.5 μm or more and 10 μm or less, the percentage of the number of the second particles is more preferably 8% or more and 25% or less, and the percentage of the number of the third particles is more preferably 75% or more and 92% or less.

The heat insulating sheet may contain, in addition to the first to third particles described above, infrared ray shielding particles each having a major axis length of more than 10 μm and/or infrared ray shielding particles each having a major axis length of less than 0.5 μm in the photograph. Infrared ray shielding particles having a major axis length of less than 0.5 μm have little effect on the heat insulating performance of the heat insulating sheet, and therefore their number is not particularly limited. For example, the number of the infrared ray shielding particles having a major axis length of less than 0.5 μm in the photograph may be 5% or less, 3% or less, or 1% or less relative to the total number of the infrared ray shielding particles present in the photograph.

On the other hand, when the number of the infrared ray shielding particles each having a major axis length of more than 10 μm becomes excessively large, these particles are more likely to connect with other infrared ray shielding particles, which may lead to deterioration of the heat insulating performance. From the viewpoint of more easily avoiding such problems and further enhancing the heat insulating performance, the sum of the percentage of the number of the first particles, the percentage of the number of the second particles, and the percentage of the number of the third particles among the infrared ray shielding particles each having a major axis length of more than 0.5 μm in the photograph is preferably 90% or more, more preferably 95% or more, particularly preferably 98% or more, and most preferably 100%.

Examples of a method for adjusting the numbers of the first particles to the third particles and the number of particles other than these particles each present in the photograph include a method for adjusting the particle size distribution of the infrared ray shielding particles used during the production of the heat insulating sheet. More specifically, for example, by a method for classifying infrared ray shielding particles, a method for using a mixture of a plurality of types of the infrared ray shielding particles having different particle size distributions from each other, a method for combining these methods, or the like, the numbers of the first particles to the third particles and the number of particles other than these particles each present in the photograph can be adjusted to fall within desired ranges.

A method for determining the presence or absence of the first particles to the third particles, and a method for counting the number of these particles are as follows. First, the heat insulating sheet is cut to obtain a test piece having a predetermined size. After a platinum coating is formed on the surface of the test piece, the test piece is processed under the conditions of an accelerating voltage of 4 kV and a processing time of 20 hours by using a sample cross section processing apparatus (for example, “Cross Section Polisher (registered trademark) SM09010” manufactured by JEOL Ltd.) to expose a cross section of the heat insulating sheet substantially parallel to the thickness direction.

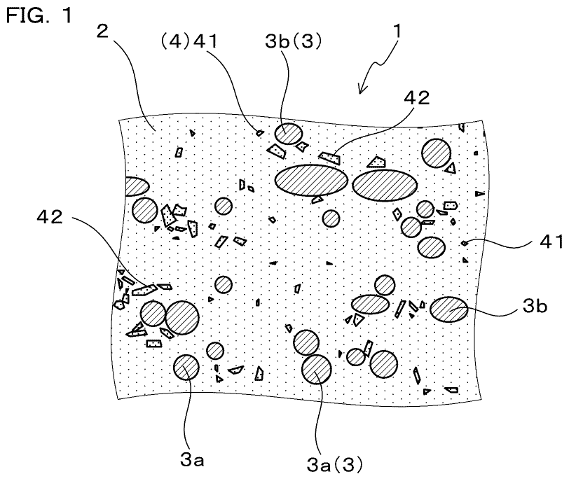

An osmium coating is formed on the cross section, and then a reflected electron image of the cross section is observed using an electron microscope, thereby creating a photograph of the cross section based on this reflected electron image. FIG. 1 shows a schematic view of the photograph of the cross section. In the photograph of the cross section of the heat insulating sheet 1, a silica aerogel 2, infrared ray shielding particles 4, and fibers 3 appear. The infrared ray shielding particles 4 have, for example, a polygonal contours. In addition, the fibers 3 have, for example, a circular or elliptical contours. For each of the infrared ray shielding particles 4 present in this photograph, the rectangle having the smallest area among rectangles circumscribing the particle is specified. The length of the long side of the rectangle thus specified is defined as a major axis length of each of the infrared ray shielding particles 4.

Based on the thus-determined major axis length, it is possible to determine whether each infrared ray shielding particle 4 is a first particle 41, a second particle 42, a third particle 43, or another type of particle. The numbers of the first particles 41 to the third particles 43 are obtained by specifying the first particles 41 to the third particles 43 according to the above-described method and then counting the number of each particle present in the photograph. If particles other than the first particle to third particle are present in the photograph, the major axis lengths and the numbers of those particles can also be measured by the same method described above.

It is noted that the above operation can also be performed using image processing software. For example, a method for measuring the major axis length of particles using the ImageJ is as follows. First, a cross-sectional photograph having a size of 960 pixels in height and 1280 pixels in width is created from a reflected electron image obtained by observing the cross section of the test piece at a magnification of 200 times using an electron microscope. Then, unnecessary portions such as a scale bar, which are not needed for image processing, are removed from the cross-sectional photograph. Next, binarization processing is performed based on the pixel value of each pixel to identify regions of the infrared ray shielding particles and regions of the fibers. Thereafter, region segmentation is performed to create a measurement image in which only the regions of the infrared ray shielding particles are extracted. At this time, a region having an area of one pixel is regarded as noise and excluded from the measurement targets of a major axis length of the infrared ray shielding particles.

Then, after the contour of the region of each infrared ray shielding particle present in the measurement image is detected, a rectangle having the smallest area among the rectangles each circumscribing a respective one of the regions is specified by rectangle fitting. The length (unit: pixel) of the long side of the rectangle is then measured, and by converting the unit, the major axis length (unit: μm) of the infrared ray shielding particle is obtained.

From the viewpoint of more accurately calculating the percentage of the first to third particles present in the photograph, it is preferable to count the numbers of the first to third particles using a photograph obtained by observing a reflected electron image of the cross section of the test piece at a magnification of 200 times with an electron microscope.

It is preferable that the infrared ray shielding particles in the photograph are unevenly distributed in the vicinity of the fibers. More specifically, a total of a number of the infrared ray shielding particles present in a region within 13 μm from a surface of each fiber is larger than a number of the infrared ray shielding particles present outside the regions. In other words, in the photograph, a first region including all regions each of which falls within 13 μm from a surface of the fiber has a larger number of the infrared ray shielding particles present than a number of the infrared ray shielding particles present in a second region other than the first region. In this case, since a relatively large number of the infrared ray shielding particles are present around the fibers, the radiant heat from the heat source is more likely to be blocked by the infrared ray shielding particles before reaching the fibers. As a result, the fibers can be protected from the radiant heat, and heat resistance can be improved. In addition, the second particles each having a relatively large particle size are easily captured by the fibers. Therefore, since a relatively large number of the infrared ray shielding particles are present near the fibers, the powder shedding is less likely to occur even when vibration, repeated loads, or the like are applied to the heat insulating sheet, making it possible to maintain heat insulating performance over a long period of time.

From the viewpoint of more reliably achieving the above-described effect, it is preferable that 70% or more of the infrared ray shielding particles in the photograph are present within a range of 13 μm from the surfaces of the fibers. In other words, a percentage of the number of the infrared ray shielding particles that are present in regions each of which falls within 13 μm from a surface of the fiber is 70% or more in total, of all the infrared ray shielding particles existing in the photograph.

From the viewpoint of achieving the effect of protecting the fibers from the radiant heat, in the photograph, all of the first particles, the second particles, and the third particles may be unevenly distributed in the vicinity of the fibers, and one or two types among the first particles, the second particles, and the third particles may be unevenly distributed in the vicinity of the fibers. On the other hand, from the viewpoint of suppressing the powder shedding, it is preferable that at least the second particles are unevenly distributed in the vicinity of the fibers. That is, the number of the second particles present within a range of 13 μm from the surfaces of the fibers is preferably larger than the number of the second particles present outside that range.

As the substance constituting the infrared ray shielding particle, for example, silicon carbide, kaolinite, montmorillonite, titanium oxide, silicon nitride, mica, alumina, aluminum nitride, boron carbide, iron oxide, magnesium oxide, tin oxide, zinc oxide, tantalum oxide, manganese ferrite, manganese oxide, nickel oxide, nickel, silver oxide, silver, bismuth oxide, carbon black, graphite, titanium, iron oxide titanium, zirconium, zirconia, zirconium silicate, barium titanate, manganese dioxide, chromium oxide, titanium carbide, tungsten carbide, tungsten oxide, niobium oxide, indium tin oxide, cerium oxide, mixtures thereof, or the like can be used. The heat insulating sheet may contain the infrared ray shielding particles composed of one type of these substances, or may contain two or more types of infrared ray shielding particles composed of substances different from each other.

From the viewpoint of further enhancing the radiant heat blocking effect, it is desirable that the infrared ray shielding particles be composed of a substance having a radiation factor of 0.6 or more in the wavelength region of infrared rays. Examples of such a substance include silicon carbide, kaolinite, silicon nitride, mica, alumina, zirconia, aluminum nitride, zirconium silicate, cerium oxide, boron carbide, manganese oxide, tin oxide, and iron oxide. In addition, from the viewpoint of scattering incident infrared rays to enhance the radiant heat blocking effect, it is also effective to use infrared ray shielding particles composed of a substance having a high refractive index in the wavelength region of infrared rays. Examples of such substances include substances having a refractive index of 2.0 or more in the wavelength region of visible light, such as silicon carbide, titanium oxide, zirconia, silicon nitride, aluminum nitride, zinc oxide, tantalum oxide, tungsten oxide, niobium oxide, cerium oxide, manganese oxide, tin oxide, bismuth oxide, iron oxide, and barium titanate.

In addition, when the infrared ray shielding particles are composed of a substance having a relatively large specific heat, the heat capacity of the infrared ray shielding particles can be increased, thereby suppressing an increase in the temperature of the particles themselves. Such substances are also excellent in heat resistance. Therefore, by using the infrared ray shielding particles composed of such substances, the heat insulating performance and heat resistance of the heat insulating sheet can be further improved. As the substance having relatively large specific heat, for example, silicon carbide, titanium oxide, silicon nitride, mica, alumina, aluminum nitride, boron carbide, iron oxide, and magnesium oxide can be preferably used. In particular, silicon carbide is suitable because an increase in thermal conductivity is small even in a high-temperature atmosphere of about 800° C.

The content of the infrared ray shielding particles in the heat insulating sheet is preferably 5 mass % or more, and more preferably 10 mass % or more. In this case, the effect of suppressing heat transfer due to radiation can be more reliably achieved. On the other hand, from the viewpoint of reducing contact of the infrared ray shielding particles with each other and/or contact with other components, thereby making it difficult to form the heat transfer path, the content of the infrared ray shielding particles in the heat insulating sheet is preferably 30 mass % or less, and more preferably 20 mass % or less.

In configuring a preferable range of the content of the infrared ray shielding particles, the upper limit and the lower limit of the content of the infrared ray shielding particles described above can be arbitrarily combined. For example, a preferable range of the content of the infrared ray shielding particles in the heat insulating sheet may be 5 mass % or more and 30 mass % or less, or may be 10 mass % or more and 20 mass % or less.

### [Fiber]

The fibers in the heat insulating sheet have an action of securing the mechanical strength of the heat insulating sheet and suppressing the powder shedding of the silica aerogel and the infrared ray shielding particles. The fibers may be inorganic fibers or organic fibers. As the inorganic fibers, for example, glass fibers, ceramic fibers, quartz fibers, alumina fibers, silica fibers, silicon carbide fibers, boron fibers, and metal fibers (examples: aluminum, iron) can be used.

As the organic fibers, for example, chemical fibers such as polyamide fibers, polyimide fibers, aromatic polyamide fibers (aramid fibers), polyolefin fibers (examples: polyethylene fibers, polypropylene fibers), fluorine fibers (examples: polytetrafluoroethylene fibers), acrylic fibers, polyparaphenylene benzbisoxazole (PBO) fibers, polyarylate fibers, nylon fibers, polyurethane fibers, polyamide fibers, polyether ether ketone (PEEK) fibers, polyether sulfone (PES) fibers, polyether imide (PEI) fibers, polyether ketone (PEK) fibers, and polyphenylene sulfide (PPS) fibers, and natural fibers such as wood fibers, silk, hemp, and wool fibers can be used. The heat insulating sheet may contain one type of fiber or may contain two or more types of fibers.

As the fibers contained in the heat insulating sheet, fibers having strength and/or heat resistance are preferably used. From such a viewpoint, the fibers contained in the heat insulating sheet are more preferably the inorganic fibers and still more preferably glass fibers.

An average diameter of the fibers in the photograph of the cross section of the heat insulating sheet is preferably 0.6 times or more and 2 times or less, more preferably 0.7 times or more and 1.7 times or less, and still more preferably 0.8 times or more and 1.5 times or less the average major axis length of the second particles. In this case, since the diameters of the fibers are appropriately larger than the major axis lengths of the second particles, the second particles are considered to be easily captured by the fibers even when vibration, repeated loads, or the like are applied to the heat insulating sheet and the second particles fall downward from their initial positions. As a result, it is considered that the powder shedding of the second particles is less likely to occur, and the heat insulating performance can be maintained over a long period of time.

The method for calculating the average diameter of the fibers in the photograph of the cross section of the heat insulating sheet is as follows. First, a photograph of a cross section of the heat insulating sheet substantially parallel to the thickness direction is obtained by a method similar to the method described above. When the cross-sectional shape of a fiber 3 is circular and the fiber 3 extends in a direction substantially perpendicular to the cross section of the sheet, the cross section of the fiber 3a appearing in the photograph becomes circular as shown in FIG. 1. Therefore, in this case, the diameter of the circle is the diameter of the fiber 3a. On the other hand, when a fiber 3 extends in a direction inclined with respect to the cross section of the sheet, the cross section of the fiber 3b appearing in the photograph becomes elliptical. Therefore, in this case, a minor axis length of the ellipse is the diameter of the fiber 3b.

Therefore, after the diameter of each of the fibers present in the photograph is determined by the method described above, the average diameter of the fibers can be calculated by arithmetically averaging these values. In addition, the average major axis length of the second particles is obtained by measuring the major axis lengths of all the second particles in the photograph by the above-described method, and then arithmetically averaging these major axis lengths.

The form how the fibers are present in the heat insulating sheet can take various forms. For example, the fibers in the heat insulating sheet may be present in a state of being separated from each other, or a plurality of the fibers may form a bundle. In addition, the fibers in the heat insulating sheet may constitute a fabric such as a woven cloth or a nonwoven cloth. Furthermore, the fibers in the heat insulating sheet may be present in two or more types of forms among these forms.

The fibers in the heat insulating sheet preferably constitute a fabric, and more preferably constitute a nonwoven cloth. In this case, the mechanical strength of the heat insulating sheet can be further improved. In the production process of the heat insulating sheet, by using a fabric (preferably a nonwoven cloth, more preferably a nonwoven cloth made of glass fibers) subjected to perforation process or fluffing process, a hole ratio and surface roughness of the surface of the heat insulating sheet can be easily adjusted.

The content of the fibers in the heat insulating sheet is preferably 20 mass % or more, and more preferably 30 mass % or more. In this case, the mechanical strength of the heat insulating sheet can be further enhanced. On the other hand, from the viewpoint of achieving the mechanical strength appropriate for the content of fibers, the content of the fibers in the heat insulating sheet is preferably 70 mass % or less, and more preferably 60 mass % or less.

In configuring a preferable range of the content of the fibers, the upper limit and the lower limit of the content of the fibers described above can be arbitrarily combined. For example, a preferable range of the content of the fibers in the heat insulating sheet may be 20 mass % or more and 70 mass % or less, or may be 30 mass % or more and 60 mass % or less.

### [Other Components]

The heat insulating sheet may be composed of the silica aerogel, the infrared ray shielding particles, and the fibers, and may contain components other than these. Examples of the optional components that can be blended in the heat insulating sheet include binders, thickeners, flame retardants, preservatives, colorants, and radiation absorbing or reflecting materials.

### Binder

The binder can reduce deterioration in a high-temperature atmosphere and suppress the formation of cracks. The binder may be composed of an inorganic material or may be composed of an organic material.

Examples of the inorganic binder include talc, carbon black, kaolinite, montmorillonite, mica, silica (examples: precipitated silica, gel-derived silica, fused silica), wollastonite, magnesium silicate, titania, metal carbide (examples, titanium carbide or tungsten carbide), metal oxide (examples: manganese oxide, nickel oxide, tin oxide, silver oxide, bismuth trioxide, chromium oxide, iron oxide, alumina, zirconia, manganese dioxide), metal nitride (examples: silicon nitride, aluminum nitride), ilmenite, zirconium silicate, potassium titanate, glass flakes, water glass (sodium silicate), calcium carbonate, barium sulfate, hydraulic materials (examples: cement, plaster, magnesium silicate), quicklime, and slaked lime. The heat insulating sheet may contain one type of the inorganic binder or two or more types of the inorganic binders.

The type of the inorganic binder to be added to the heat insulating sheet is not particularly limited, and an appropriate inorganic binder may be blended depending on the characteristics and the like of the inorganic binder. For example, silica is preferable in terms of being easily compatible with silica aerogel and being inexpensive and easily available. In addition, hydraulic material is preferable in terms of reacting with water, which is typically used as a solvent during preparation of silica aerogel, to bind the constituent materials while filling gaps between the silica fine particles, so that a high strength heat insulating sheet can be formed, and in terms of being inexpensive and easily available. As the inorganic binder, an inorganic binder having a large specific surface area and hardness may be selected.

As the organic binder, it is preferable to use an aqueous binder that can be dissolved or dispersed in water (can form an emulsion). As the organic binder, a substance that introduce a hydrophilic group to the silica aerogel, or a so-called surfactant can also be used.

The glass transition temperature (Tg) of the organic binder is preferably −5° C. or lower, and more preferably −20° C. or lower. Such an organic binder is excellent in adhesiveness to the silica aerogel. Furthermore, by using the organic binder having the glass transition temperature within the above-described specific range, the flexibility of the heat insulating sheet can be improved, and the formation of cracks can be suppressed.

Examples of the organic binder include resins such as acrylic resin, urethane resin, and mixtures of acrylic resin and urethane resin; and rubbers such as styrene-butadiene rubber (SBR), nitrile rubber, silicone rubber, urethane rubber, and acrylic rubber. Among them, the organic binder is preferably urethane resin and/or SBR. In this case, the flexibility of the heat insulating sheet can be further improved, and a flexible sheet can be achieved. When the organic binder is used, a crosslinking agent may be further used in combination. In this case, the organic binder can be crosslinked to further improve the strength of the sheet.

### Thickener

The thickener can enhance dispersibility of the silica aerogel in a solvent (typically water) and can enhance processability. In addition, the thickener can also improve the flexibility of the heat insulating sheet and suppress the formation of cracks. Examples of the thickener include polysaccharides such as carboxymethyl cellulose (CMC), carboxyethyl cellulose, carboxypropyl cellulose, hydroxyethyl cellulose, hydroxypropyl cellulose, xanthan gum, agarose, carrageenan, and glucomannan; polyethylene oxide (PEO); and polyvinyl alcohol.

### Flame Retardant

The flame retardant can enhance flame retardancy of the heat insulating sheet. As the flame retardant, for example, halogen-based flame retardants, phosphorus-based flame retardants, and metal hydroxide-based flame retardants can be used. As the flame retardant, phosphorus-based flame retardants (examples: ammonium polyphosphate, red phosphorus, phosphate ester) are preferably used, a phosphorus-based flame retardant insoluble in water is more preferably used, and ammonium polyphosphate is still more preferably used.

### [Structure of Heat Insulating Sheet]

The thickness of the heat insulating sheet is not particularly limited, and may be, for example, 10 mm or less, 8 mm or less, 3 mm or less, 2.5 mm or less, or 2 mm or less. Thus, the strength of the sheet can be maintained within a range of an appropriate thickness. The lower limit of the thickness of the heat insulating sheet may be, for example, 0.1 mm. The lower limit of the thickness of the heat insulating sheet is preferably 0.5 mm, and more preferably 1 mm. The thickness of the heat insulating sheet is preferably substantially uniform over the entire heat insulating sheet. For example, the variation of the thickness of the heat insulating sheet may be 5% or less, 4% or less, or 3% or less.

At least one surface of the heat insulating sheet in the thickness direction may be provided with an uneven shape, a plurality of holes, and the like. The position and shape of the hole provided in the heat insulating sheet are not particularly limited, and can take various forms. For example, the holes may be disposed at regular intervals or disposed randomly on the surface of the heat insulating sheet. Examples of the shape of the hole include a circular shape, a polygonal shape, and an irregular shape. The uneven shape provided on the heat insulating sheet may be disposed over the entire surface or on a part of the surface of the heat insulating sheet. In addition, recessed portions and protruding portions in the uneven shape may be uniformly disposed over the entire surface, or may be unevenly disposed at a part of the surface.

When both the uneven shape and/or the holes are provided on a first surface and a second surface of the heat insulating sheet in the thickness direction, the properties of the first surface and the properties of the second surface may be the same or different from each other. From the viewpoint of more effectively suppressing the powder shedding from the heat insulating sheet, it is preferable that the properties of the first surface and the properties of the second surface of the heat insulating sheet are different from each other. That is, for example, when the holes are provided on both the first surface and the second surface, the number of the holes provided on the first surface is preferably larger than the number of the holes provided on the second surface. For example, when the uneven shape is provided on both the first surface and the second surface, the surface roughness of the first surface is preferably larger than the surface roughness of the second surface.

When the heat insulating sheet is disposed between battery cells, the magnitude of external forces or vibration applied to one surface of the heat insulating sheet in the thickness direction may be larger than the magnitude of external forces or vibration applied to the other surface. In this case, by disposing the heat insulating sheet such that the magnitude of external forces or vibration applied to the first surface are larger than the magnitude of external forces or vibration applied to the second surface, the powder of the constituent material of the heat insulating sheet generated from the first surface by the external force, the vibration, or the like can be easily captured by the holes or the recessed portions on the surface. In addition, since the first surface has a predetermined shape and/or is formed of the fibers, adhesiveness with a film or the like can be enhanced. Therefore, even when external forces, vibration, or the like are applied to the heat insulating sheet, peeling between the film or the like and the silica aerogel or the like can be suppressed.

On the other hand, by disposing the heat insulating sheet as described above, the magnitude of the external forces and the vibration applied to the second surface can be reduced, and the powder of the constituent material of the heat insulating sheet generated from the second surface by the external force, the vibration, and the like can be reduced. Therefore, even when the number of the holes of the second surface is smaller than that of the first surface, or even when the surface roughness of the second surface is smaller than that of the first surface, the powder of the constituent material of the heat insulating sheet generated from the second surface can be easily captured. Furthermore, since the holes and the uneven shape provided on the surface themselves cause the powder shedding, the powder shedding caused by the holes and the uneven shape can be suppressed by reducing the number of the holes on the second surface or reducing the surface roughness of the second surface.

Therefore, by disposing the heat insulating sheet, in which the properties of the first surface and the properties of the second surface are different from each other, in a direction depending on the magnitude of external forces or vibration, the powder shedding from the heat insulating sheet can be suppressed.

### [Application]

Since the heat insulating sheet is excellent in the balance between the effect of suppressing powder shedding and heat insulating properties, the heat insulating sheet can be suitably used as the heat insulating sheet between the battery cells for an automobile. More specifically, by disposing the heat insulating sheet between the cells of the battery for the automobile, heat transfer between the cells can be reduced.

When the properties of the first surface and the properties of the second surface of the heat insulating sheet are different from each other, as described above, the heat insulating sheet is preferably arranged in a direction in which a stress generated on the first surface, that is, a surface having a large number of the holes and/or a large surface roughness is larger than a stress generated on the second surface. More specifically, the first surface is preferably disposed at a position closer to the battery cell, a position closer to the vibration source, a position closer to the motor, or the like than the second surface. By disposing the heat insulating sheet in this manner, the powder shedding from the heat insulating sheet can be suppressed, and the heat insulating performance can be further enhanced.

### (Heat Insulating Material)

The heat insulating material can be obtained by layering the heat insulating sheet and other members. The heat insulating material may include, for example, in addition to the heat insulating sheet, a film, an elastic layer, a base material layer, and an adhesive layer.

### [Film]

The heat insulating material may further include a film covering at least one surface of the heat insulating sheet in the thickness direction. By covering the surface of the heat insulating sheet with the film, powder shedding from the surface can be further suppressed. The film may cover only one surface of the heat insulating sheet in the thickness direction. Alternatively, the entire heat insulating sheet may be covered and sealed with the film.

When the properties of the first surface and the properties of the second surface of the heat insulating sheet are different from each other, the film preferably covers at least the first surface, namely, a surface having a large number of the holes and/or a large surface roughness, and more preferably covers both the first surface and the second surface. By covering at least the first surface among the surfaces of the heat insulating sheet with the film in this way, powder shedding can be more effectively suppressed. From the viewpoint of further enhancing this effect, it is preferable to arrange the heat insulating sheet in a direction in which external forces or vibration applied to the first surface are larger than external forces or vibration applied to the second surface.

The material constituting the film is not particularly limited. For example, the film may be composed of polyimide, polycarbonate, PET, p-phenylene sulfide, polyetherimide, crosslinked polyethylene, flame-retardant chloroprene rubber, polyvinylidene fluoride, rigid vinyl chloride, polybutylene terephthalate, PTFE, PFA, FEP, ETFE, rigid PCV, flame-retardant PET, polystyrene, polyethersulfone, polyamideimide, polyacrylonitrile, polyethylene, polypropylene, or polyamide.

### [Elastic Layer]

The heat insulating material may include the elastic layer that relieves stress generated in the heat insulating sheet and applies a compressive load to the battery cell. The elastic layer may be provided on one surface of the heat insulating sheet in the thickness direction, or may be provided on both surfaces. When the properties of the first surface and the properties of the second surface of the heat insulating sheet are different from each other, the elastic layer is preferably provided at least on the first surface. In this case, the effect of relieving the stress described above can be utilized more effectively. From the viewpoint of further enhancing this effect, it is preferable to arrange the heat insulating sheet in a direction in which external forces or vibration applied to the first surface are larger than external forces or vibration applied to the second surface.

As the substance constituting the elastic layer, a material having rubber elasticity can be used. For example, the elastic layer may be composed of natural rubber or synthetic rubber. The main component of the elastic layer is preferably polyisoprene, hydrogenated polyisoprene, polybutadiene, styrene-butadiene copolymer, isobutylene-isoprene copolymer, ethylene-propylene copolymer, ethylene-propylene-diene terpolymer (EPDM), or silicone.

The shape of the elastic layer can take various forms. The elastic layer preferably has a ridge portion on the back side of the surface that is in contact with the heat insulating sheet (for example, the surface in contact with the cell). In this case, the stress generated in the heat insulating sheet can be further relaxed. As a result, powder shedding can be suppressed more effectively.

### [Laminating Method]

The methods for laminating the heat insulating sheet and the other layer(s) can take various forms. For example, a slurry containing constituent materials of the heat insulating sheet is applied to at least one surface of a layer to be laminated with the heat insulating sheet, and then the slurry is dried to laminate the heat insulating sheet and the other layer. For the application of the slurry, a known application apparatus such as a blade coater, a bar coater, a die coater, a comma coater (registered trademark), a roll coater, or a brush can be used as necessary. The temperature for drying the slurry can be appropriately set within a range, for example, from 80° C. to 180° C. The time for drying the slurry can be appropriately set within a range, for example, from several minutes to several tens of minutes.

Alternatively, the heat insulating sheet and the other layer(s) may be laminated by a method in which the heat insulating sheet and the other layer(s) are prepared separately and bonded to each other via an adhesive layer. Examples of the material constituting the adhesive layer include epoxy resin, phenolic resin, acrylic resin, melamine resin, vinyl acetate resin, silicone resin, urethane resin, polyethylene, and polypropylene.

Furthermore, for example, the heat insulating sheet can be sealed by storing the heat insulation sheet in a film formed into a bag shape and then closing an opening of the film.

### (Method for Producing Heat Insulating Sheet)

The method for producing the heat insulating sheet can take various forms. The heat insulating sheet can be produced, for example, by a method for compression-molding a mixture containing the silica aerogel particles, the infrared ray shielding particles, the fibers, and an appropriate dispersion medium, and then drying the dispersion medium. The heat insulating sheet obtained by such a method has a structure in which the infrared ray shielding particles and the fibers are held in gaps between the silica aerogel particles.

Alternatively, the heat insulating sheet may be produced, for example, by a method for preparing a sheet precursor in which the fibers are impregnated with a wet gel containing the silica fine particles and the infrared ray shielding particles dispersed in the wet gel, and drying the wet gel in the sheet precursor to form the heat insulating sheet. In this case, the heat insulating sheet having desired characteristics can be more easily obtained.

The method for preparing the sheet precursor can take various forms. For example, the sheet precursor can be obtained by impregnating the fibers with a dispersion containing a hydrolyzable silane compound and the infrared ray shielding particles, hydrolyzing the silane compound in the dispersion to form a sol of the silica fine particles, and then gelating the sol. The sheet precursor can also be obtained by dispersing the infrared ray shielding particles in a sol of the silica fine particles, impregnating the fibers with the dispersion, and then gelating the sol. Furthermore, the sheet precursor can also be obtained by mixing a wet gel and the infrared ray shielding particles to produce a dispersion, and impregnating the fibers with the dispersion. By drying the sheet precursor obtained by these methods, the heat insulating sheet having a structure in which gaps between the fibers are filled with the silica aerogel and the infrared ray shielding particles are dispersed in the silica aerogel can be obtained. From the viewpoint of more easily obtaining the heat insulating sheet having the desired characteristics, it is more preferable to prepare the sheet precursor by impregnating the fibers with a sol of the silica fine particles and the then gelating the sol.

The sol containing the silica fine particles can be obtained, for example, by preparing a silane solution containing a hydrolyzable silane compound and the infrared ray shielding particles, and then hydrolyzing the silane compound in the silane solution. When the hydrolysis is performed, ice cooling or stirring of the silane solution may be performed as necessary. The hydrolysis of the silane compound can also be performed in a state where the fibers are impregnated with the silane solution.

Examples of the hydrolyzable silane compound include methyltrimethoxysilane (MTMS), trimethylmethoxysilane (TMS), dimethyldimethoxysilane (DMS), trimethylethoxysilane, dimethyldiethoxysilane (DMDS), methyltriethoxysilane (MTES), ethyltriethoxysilane (ETES), diethyldiethoxysilane, ethyltriethoxysilane, propyltrimethoxysilane, propyltriethoxysilane, phenyltrimethoxysilane, phenyltriethoxysilane (PhTES), hexamethyldisilazane, and hexaethyldisilazane.

Examples of the solvent of the silane solution include water, methanol, ethanol, isopropanol, ethyl acetate, ethyl acetoacetate, acetone, dichloromethane, and tetrahydrofuran. The solvent of the silane solution is preferably an acidic aqueous solution, and more preferably an acetic acid aqueous solution. The silane solution may contain a hydrolyzable compound such as urea. Furthermore, the silane solution may contain a surfactant such as aliphatic ammonium or alkylbenzylammonium as necessary.

The method for gelating the sol containing the silica fine particles is not particularly limited, and for example, a method for leaving the sol in a sealed container, a method for adding an appropriate catalyst to the sol, or a method for irradiating the sol with energy rays such as ultraviolet rays can be adopted. Among them, it is preferable to gel the sol by leaving the sol in the sealed container. When the sol is left in the sealed container, the sol can be heated to, for example, a temperature of 50° C. or higher or 60° C. or higher as necessary.

By gelating the sol, a wet gel is formed. The silica aerogel can be obtained by drying the wet gel to remove the liquid dispersion medium and unreacted products contained in the gel. As a method for drying the wet gel, various methods such as supercritical drying, normal pressure drying, freeze drying, and drying under environmental pressure can be adopted. In the case of performing supercritical drying, a supercritical fluid such as supercritical carbon dioxide gas may be brought into contact with the wet gel so that the supercritical fluid replaces the liquid dispersion medium or the like. During drying, the sheet precursor may be compressed as necessary. This allows the variation in thickness of the heat insulating sheet to be reduced.

In the production process of the heat insulating sheet, holes may be formed as necessary by a method such as perforation. This allows the surface property of the sheet to be adjusted. The timing of forming the holes is not particularly limited, and the holes can be formed at any stage in the production process of the heat insulating sheet.

In the production process of the heat insulating sheet, a hydrophobic treatment on the gel may be performed as necessary. In the hydrophobic treatment, a trimethylsilylating agent is reacted with the wet gel or the silica aerogel. This allows hydrophilic functional groups (e.g., hydroxyl groups) on the silica surface to be converted into hydrophobic functional groups (e.g., trimethylsilyl groups). The timing of performing the hydrophobic treatment may be any time after the silica fine particles are formed. From the viewpoint of further simplifying the production process of the heat insulating sheet, it is preferable to perform the hydrophobic treatment on the wet gel.

When the hydrophobic treatment is performed, the treatment is preferably performed so that the content of the hydrophobized silica with respect to the mass of the heat insulating sheet is 5 mass % or more, and more preferably 7 mass % or more. On the other hand, the content of the hydrophobized silica with respect to the mass of the heat insulating sheet is preferably 30 mass % or less, and more preferably 25 mass % or less. In addition, the mass proportion of the hydrophobized silica to the non-hydrophobized silica (hydrophobized/non-hydrophobized) is preferably 0.1 or more, and more preferably 0.2 or more. On the other hand, the mass proportion of the hydrophobized silica to the non-hydrophobized silica is preferably 1.5 or less, more preferably 1.2 or less, and still more preferably 1.0 or less.

### EXAMPLES

Experimental examples of the heat insulating sheet and a method for producing the same will be described below.

### Experimental Example 1

The heat insulating sheet of the present example is produced by preparing a sheet precursor in which fibers are impregnated with a wet gel containing silica fine particles and infrared ray shielding particles dispersed in the gel, and then drying the gel in the sheet precursor. A method for producing the heat insulating sheet of the present example will be described in detail below.

First, 1.00 g of cetyltrimethylammonium bromide (another name: hexadecyltrimethylammonium bromide; manufactured by NACALAI TESQUE, INC., hereinafter abbreviated as “CTAB”) as a cationic surfactant was dissolved in 10.00 g of an acetic acid aqueous solution having a concentration of 0.01 mol/L. To this acidic aqueous solution, 0.50 g of urea (manufactured by NACALAI TESQUE, INC.) as the hydrolyzable compound was added and dissolved.

Thereafter, 5.0 mL of methyltrimethoxysilane (“LS-530” manufactured by Shin-Etsu Chemical Co., Ltd., specific gravity: 0.95, hereinafter abbreviated as “MTMS”) as a hydrolyzable silane compound was added to the acidic aqueous solution. The acidic aqueous solution after the addition of MTMS was stirred and mixed under ice cooling for 30 minutes to hydrolyze MTMS, thereby forming the silica fine particles in the aqueous solution. As a result, the sol of the silica fine particles was prepared. Then, 0.7 g of silicon carbide particles subjected to particle size adjustment was added to the sol to obtain a dispersion in which the silicon carbide particles were dispersed in the sol. Thereafter, the dispersion was left in an atmosphere at 60° C. for 3 hours to partially gel the sol in the dispersion.

It is noted that the silicon carbide particles used in the present example are obtained by classifying a mixed powder of a silicon carbide powder having a particle size of #400 and a silicon carbide powder having a particle size of #6000. For the classification of the mixed powder, for example, a known classifier such as a centrifugal classifier (“Turboplex” (registered trademark) manufactured by Hosokawa Micron Corporation) or an air flow classifier (“Elbow-Jet” (registered trademark) manufactured by Nittetsu Mining Co., Ltd.) can be used.

Next, a glass fiber nonwoven fabric (“Nitigura Mat MNA-300-1000-30m” manufactured by Nihon Glass Fiber Industrial Co., Ltd., thickness 3 mm) was placed on a polypropylene film having a thickness of 50 μm and impregnated with the dispersion. Then the nonwoven fabric was sealed in a sealed container together with the polypropylene film. Thereafter, the nonwoven fabric in the sealed container was left to stand for 96 hours, allowing the sol in the nonwoven fabric to completely gel and the gel to age. As described above, the sheet precursor containing the wet gel was obtained.

The sheet precursor thus obtained was taken out from the sealed container, and the moisture in the sheet precursor was then replaced with 2-propanol. More specifically, the sheet precursor was immersed in 2-propanol at 60° C. for 24 hours, and then the heat insulating sheet was taken out from 2-propanol. After replacing of 2-propanol, the resultant product was immersed in 2-propanol at 60° C. for 48 hours to perform solvent exchange.

Next, supercritical drying was performed by the following method to dry the gel in the sheet precursor and obtain the silica aerogel. First, the sheet precursor after the solvent exchange was placed in an autoclave filled with 2-propanol and having a volume of 400 mL. After a lid of the autoclave was closed, the inside of the autoclave was pressurized using liquefied carbon dioxide until the pressure reached 882 N/cm² (about 90 kgf/cm²). This pressure was maintained for 1.5 hours to perform a first liquid phase exchange. After the first liquid phase exchange was completed, the supply of the liquefied carbon dioxide was stopped. Thereafter, while maintaining the sealed state of the autoclave, the system was left to stand for 17.5 hours to allow the liquefied carbon dioxide to diffuse into the gel.

Subsequently, the inside of the autoclave was pressurized again using liquefied carbon dioxide until the pressure reached 882 N/cm² (about 90 kgf/cm²). This pressure was maintained for 1 hour to perform a second liquid phase exchange. After the second liquid phase exchange was completed, the supply of the liquefied carbon dioxide was stopped. Thereafter, while maintaining the sealed state of the autoclave, the system was left to stand for 5 hours to allow the liquefied carbon dioxide to diffuse into the gel.

Subsequently, the inside of the autoclave was pressurized again using liquefied carbon dioxide until the pressure reached 882 N/cm² (about 90 kgf/cm²). This pressure was maintained for 0.75 hours to perform a third liquid phase exchange. After the third liquid phase exchange was completed, the supply of the liquefied carbon dioxide was stopped. Thereafter, while maintaining the sealed state of the autoclave, the temperature inside the autoclave was increased from room temperature to 80° C. over a period of 1.5 hours.

After the temperature inside the autoclave reached 80° C., the pressure inside the autoclave was reduced to atmospheric pressure at a pressure reduction rate of 4.9 N/(cm²·min) (0.5 kgf/(cm²·min)). After the pressure in the autoclave reached atmospheric pressure, the inside of the autoclave was cooled to room temperature over a period of 2 hours.

The heat insulating sheet of Experimental Example 1 was obtained by the above method. The thickness of the heat insulating sheet of Experimental Example 1 was 3 mm. Among the surfaces of the heat insulating sheet in the thickness direction, the surface roughness of a surface not in contact with the film was larger than the surface roughness of a surface in contact with the film. Therefore, in the heat insulating sheet of the present example, the surface not in contact with the film is the first surface, and the surface in contact with the film is the second surface.

### Experimental Example 2 to 15

The methods for producing the heat insulating sheets of these experimental examples are substantially the same as the method for producing the heat insulating sheet of Experimental Example 1, except for the change in the particle size distribution of the silicon carbide particles.

### (Percentages of First Particles to Third Particles)

Tables 1 to 4 show the percentages of the numbers of the first particles, the second particles, and the third particles each present in the photographs of the cross sections of the heat insulating sheets of Experimental Example 1 to 15. In the present examples, a scanning electron microscope (“SEM S-3400N” manufactured by Hitachi, Ltd.) was used, and a backscattered electron image of a cross section was observed under the conditions of an accelerating voltage of 15 kV and a magnification of 200 times to produce a cross-sectional photograph having a size of 960 pixels in height and 1280 pixels in width. Subsequently, unnecessary parts such as a scale bar were removed from the photograph for image processing. The size of the photograph after removal of the scale bar and the like was 895 pixels in height and 1280 pixels in width. Based on the scale bar, the actual size of this photograph was converted to 443.1 μm in height and 633.7 μm in width. Using the cross-sectional photograph thus obtained, the major axis length of each particle was measured, and the percentage of the number of each particle was calculated according to the method described above.

### (Evaluation of Powder Shedding Suppression Effect)

The heat insulating sheet was cut to prepare a small piece having a square shape with a side of 5 cm. Both surfaces of the small piece were covered with PET films, each having a thickness of 50 μm. Then, one of the PET films was bonded to a rubber sheet to produce a sample. The rubber sheet has a structure in which a plurality of ridge portion units are connected to each other. Each ridge portion unit includes, in a cross section, a protruding part having a base width of 10.86 mm, a height of about 7 mm, and a taper of 60°, and a recessed part around the protruding part. The protruding part extends in the width direction. The total width including the recessed part and the protruding part is about 20.5 mm. The rubber sheet was arranged such that the recessed part of each ridge portion unit faced the film.

Subsequently, the sample was attached to a jig of a vibrator. The jig includes a pair of metal plates and a powder receiver. The sample was arranged upright between the metal plates so that the surface of the heat insulating sheet in the thickness direction was oriented substantially vertically. The sample was then fixed while being pressurized so as to be in a compressed state by 50%.

After the sample was mounted to the jig as described above, a vibration test was performed by applying vibration to the sample 800,000 times under the conditions of an acceleration of 3G and a frequency of 5 Hz. After the completion of the vibration test, the rubber sheet was removed from the sample. Thereafter, the film was peeled off from the surface of the heat insulating sheet, and the powder fallen from the heat insulating sheet was collected.

Next, the mass ratio of the silicon carbide particles contained in the powder fallen from the heat insulating sheet was calculated by the following method. First, the silica aerogel, the silicon carbide particles, and a mixture obtained by mixing the silica aerogel and the silicon carbide particles with a mass ratio of 1:1 were prepared, each having a predetermined mass, and their volumes were measured. Subsequently, the volumes of the silica aerogel, the silicon carbide particles, and the mixture thereof were plotted on a graph in which the vertical axis represents the mass ratio of the silicon carbide particles and the horizontal axis represents the volume. Then, these three plot points were approximated by a straight line to create a calibration curve.

Subsequently, a sample having the same mass as the mass of the silica aerogel or the like used for creating the calibration curve was collected from the powder fallen from the heat insulating sheet, and the volume of the sample was measured. Then, based on the calibration curve described above, the volume of the sample was converted into the mass ratio of the silicon carbide particles contained in the sample.

The powder shedding suppression effect was evaluated based on the mass ratio of the silicon carbide particles in the sample obtained as described above. In the “Powder shedding suppression effect” columns in Tables 1 to 4, with the mass ratio of the silicon carbide particles in Experimental Example 6 being used as a reference: symbol “A” was assigned when the mass ratio of the silicon carbide particles was ⅕ or less; symbol “B” was assigned when the mass ratio was more than ⅕ and ¼ or less; symbol “C” was assigned when the mass ratio was more than ¼ and ⅓ or less; symbol “D” was assigned when the mass ratio was more than ⅓ and ½ or less; symbol “E” was assigned when the mass ratio was more than ½ and 1 or less; and symbol “F” was assigned when the mass ratio was more than 1. In the “Powder shedding suppression effect” column of Experimental Example 6, which served as the reference, symbol “-” is described.

TABLE 1

| | | Experimental | Experimental | Experimental | Experimental | Experimental |
|---|---|---|---|---|---|---|
| | Unit | Example 1 | Example 2 | Example 3 | Example 4 | Example 5 |
| Number of first particles | % | 10 | 5 | 15 | 15 | 4 |
| Number of second particles | % | 10 | 15 | 5 | 15 | 16 |
| Number of third particles | % | 80 | 80 | 80 | 70 | 80 |
| Number of first | — | 1:1 | 1:3 | 3:1 | 1:1 | 1:4 |
| particles:number of | | | | | | |
| second particles | | | | | | |
| Powder shedding | — | A | B | C | A | B |
| suppression effect | | | | | | |

TABLE 2

| | | Experimental | Experimental | Experimental |
|---|---|---|---|---|
| | Unit | Example 6 | Example 7 | Example 8 |
| Number of first particles | % | 5 | 10 | — |
| Number of second particles | % | — | — | 10 |
| Number of third particles | % | 95 | 90 | 90 |
| Number of first particles:number | — | — | — | — |
| of second particles | | | | |
| Powder shedding | — | — | E | D |
| suppression effect | | | | |

TABLE 3

| | | Experimental | Experimental | Experimental | Experimental |
|---|---|---|---|---|---|
| | Unit | Example 9 | Example 10 | Example 11 | Example 12 |
| Number of first particles | % | 1 | 5 | 16 | 2 |
| Number of second particles | % | — | 5 | 4 | 2 |
| Number of third particles | % | 99 | 90 | 80 | 96 |
| Number of first particles:number | — | — | 1:1 | 4:1 | 1:1 |
| of second particles | | | | | |
| Powder shedding | — | F | D | C | E |
| suppression effect | | | | | |

TABLE 4

| | | Experimental | Experimental | Experimental |
|---|---|---|---|---|
| | Unit | Example 13 | Example 14 | Example 15 |
| Number of first particles | % | 4 | 9 | 12 |
| Number of second particles | % | 12 | 9 | 4 |
| Number of third particles | % | 84 | 82 | 96 |
| Number of first particles:number | — | 1:3 | 1:1 | 3:1 |
| of second particles | | | | |
| Powder shedding | — | B | A | C |
| suppression effect | | | | |

As shown in Tables 1 to 4, in the photographs of the cross sections of the heat insulating sheets of Experimental Examples 1 to 5, 8, 10, 11, and 13 to 15, the second particles composed of the infrared ray shielding particles each having the major axis length of 5 μm or more and 10 μm or less are present. In the photographs, the percentage of the number of the second particles to the infrared ray shielding particles each having the major axis length of 0.5 μm or more and 10 μm or less is 4% or more and 30% or less. Therefore, these heat insulating sheets were able to suppress the powder shedding more than the heat insulating sheet of Experimental Example 6 (see Table 2), which contained no second particles. In addition, since the powder shedding is less likely to occur in the heat insulating sheets of Experimental Examples 1 to 5, 8, 10, 11, and 13 to 15 than in the heat insulating sheet of Experimental Example 6, these heat insulating sheets can maintain the state in which the infrared ray shielding particles are retained for a long period of time. Therefore, the heat insulating sheets of these experimental examples can maintain good heat insulating performance over a long period of time.

On the other hand, the heat insulating sheet of Experimental Example 7 shown in Table 2 does not contain the second particles, similarly to Experimental Example 6. Therefore, the powder shedding was likely to occur in the heat insulating sheet of Experimental Example 7, as in the heat insulating sheet of Experimental Example 6.

The heat insulating sheet of Experimental Example 9 shown in Table 3 had a smaller number of the first particles than the heat insulating sheet of Experimental Example 6. Therefore, the powder shedding was even more likely to occur than in the heat insulating sheet of Experimental Example 6.

The number of the second particles contained in the heat insulating sheet of Experimental Example 12 was smaller than the above-mentioned specific range. Therefore, the powder shedding was more likely to occur in the heat insulating sheet of Experimental Example 12 than those of Experimental Example 1 to 5, 8, 10 to 11, and 13 to 15.

Although the aspects of the heat insulating sheet and the method for producing the same have been described above based on experimental examples, the specific aspects of the heat insulating sheet and the method for producing the same according to the present disclosure are not limited to the aspects of the experimental examples, and the configuration can be appropriately changed within a range not impairing the gist of the present disclosure.

For example, the heat insulating sheet for heat insulation between battery cells of an electric vehicle may take forms as in the following [1-1] to [1-6].
[1-1] A heat insulating sheet for heat insulation between battery cells of an electric vehicle, the sheet comprising:
a silica aerogel;
fibers; and
infrared ray shielding particles, wherein
in a photograph obtained by observing a cross section of the sheet under conditions of a magnification of 200 times and an acceleration voltage of 15 kV using an electron microscope, second particles composed of the infrared ray shielding particles each having a major axis length of 5 μm or more and 10 μm or less are present and third particles composed of the infrared ray shielding particles each having a major axis length of more than 1 μm and less than 5 μm,
a total of a number of the infrared ray shielding particles present in a region within 13 μm from a surface of each fiber is larger than a number of the infrared ray shielding particles present outside the regions,
in the photograph, a percentage of a number of the second particles in the infrared ray shielding particles each having a major axis length of 0.5 μm or more and 10 μm or less is 10% or more and 16% or less, and
a percentage of a number of the third particles to the infrared ray shielding particles each having a major axis length of 0.5 μm or more and 10 μm or less in the photograph is 70% or more and 90% or less.
[1-2] The heat insulating sheet according to [1-1], a percentage of the infrared ray shielding particles that are present in regions each of which falls within 13 μm from a surface of the fiber is 70% or more in total, of all the infrared ray shielding particles existing in the photograph.
[1-3] The heat insulating sheet according to [1-1] or [1-2], wherein in the photograph, an average diameter of the fibers is 0.6 times or more and 2 times or less an average major axis length of the second particles.
[1-4] The heat insulating sheet according to any one of [1-1] to [1-3], wherein gaps between the fibers are filled with the silica aerogel, and the infrared ray shielding particles are dispersed in the silica aerogel.
[1-5] The heat insulating sheet according to any one of [1-1] to [1-4], wherein the infrared ray shielding particles include silicon carbide particles.
[1-6] The heat insulating sheet according to any one of [1-1] to [1-5], wherein the content of the infrared ray shielding particles in the heat insulating sheet is 5 mass % or more and 30 mass % or less.

The method for producing heat insulating sheet for heat insulation between battery cells of an electric vehicle may take forms as in the following [1-7].
[1-7] A method for producing the heat insulating sheet according to any one of [1-1] to [1-6], the method comprising:
preparing a sheet precursor in which the fibers are impregnated with a wet gel containing silica fine particles and the infrared ray shielding particles dispersed in the wet gel; and
drying the wet gel in the sheet precursor to form the heat insulating sheet.

The heat insulating sheet for heat insulation between battery cells of an electric vehicle may take forms as in the following [2-1] to [1-11].
[2-1] A heat insulating sheet for heat insulation between battery cells of an electric
vehicle, the sheet comprising:
a silica aerogel;
fibers; and
infrared ray shielding particles, wherein
second particles composed of the infrared ray shielding particles each having a major axis length of 5 μm or more and 10 μm or less are present in a photograph obtained by observing a cross section of the sheet, and
in the photograph, a percentage of a number of the second particles in the infrared ray shielding particles each having a major axis length of 0.5 μm or more and 10 μm or less is 4% or more and 30% or less.
[2-2] The heat insulating sheet according to [2-1], wherein first particles composed of the infrared ray shielding particles each having a major axis length of 0.5 μm or more and 1 μm or less are further present in the photograph.
[2-3] The heat insulating sheet according to [2-2], wherein a ratio of a number of the first particles to the number of the second particles each present in the photograph is first particles:second particles=1:4 to 4:1.
[2-4] The heat insulating sheet according to [2-2] or [2-3], wherein in the photograph, a sum of a percentage of the number of the first particles and the percentage of the number of the second particles in the infrared ray shielding particles each having a major axis length of 0.5 μm or more and 10 μm or less is 5% or more and 30% or less.
[2-5] The heat insulating sheet according to any one of [2-1] to [2-4], wherein third particles composed of the infrared ray shielding particles each having a major axis length of more than 1 μm and less than 5 μm are further present in the photograph.
[2-6] The heat insulating sheet according to [2-5], wherein in the photograph, a percentage of the number of the third particles to the infrared ray shielding particles each having a major axis length of 0.5 μm or more and 10 μm or less is 70% or more and 96% or less.
[2-7] The heat insulating sheet according to any one of [2-1] to [2-6], wherein in the photograph, a total of a number of the infrared ray shielding particles present in a region within 13 μm from a surface of each fiber is larger than a number of the infrared ray shielding particles present outside the regions.
[2-8] The heat insulating sheet according to any one of [2-1] to [2-7], wherein a percentage of the infrared ray shielding particles that are present in regions each of which falls within 13 μm from a surface of the fiber is 70% or more in total, of all the infrared ray shielding particles existing in the photograph.
[2-9] The heat insulating sheet according to any one of [2-1] to [2-8], wherein in the photograph, an average diameter of the fibers is 0.6 times or more and 2 times or less an average major axis length of the second particles.
[2-10] The heat insulating sheet according to any one of [2-1] to [2-9], wherein gaps between the fibers are filled with the silica aerogel, and the infrared ray shielding particles are dispersed in the silica aerogel.
[2-11] The heat insulating sheet according to any one of [2-1] to [2-10], wherein the infrared ray shielding particles include silicon carbide particles.

The method for producing heat insulating sheet for heat insulation between battery cells of an electric vehicle may take forms as in the following [2-12].
[2-12] A method for producing the heat insulating sheet according to any one of [2-1] to [2-11], the method comprising:
preparing a sheet precursor in which the fibers are impregnated with a wet gel containing silica fine particles and the infrared ray shielding particles dispersed in the wet gel; and
drying the wet gel in the sheet precursor to form the heat insulating sheet.

What is claimed is:

1. A heat insulating sheet for heat insulation between battery cells of an electric vehicle, the sheet comprising:
a silica aerogel;
fibers; and
infrared ray shielding particles, wherein
in a photograph obtained by observing a cross section of the sheet, first particles composed of the infrared ray shielding particles each having a major axis length of 0.5 μm or more and 1 μm or less and second particles composed of the infrared ray shielding particles each having a major axis length of 5 μm or more and 10 μm or less are present,
a ratio of a number of the first particles to a number of the second particles each present in the photograph is first particles:second particles=1:4 to 3:1, and
in the photograph, a sum of a percentage of the number of the first particles and a percentage of the number of the second particles in the infrared ray shielding particles each having a major axis length of 0.5 μm or more and 10 μm or less is 20% or more and 30% or less.

2. The heat insulating sheet according to claim 1, wherein in the photograph, an average diameter of the fibers is 0.6 times or more and 2 times or less an average major axis length of the second particles.

3. The heat insulating sheet according to claim 1, wherein gaps between the fibers are filled with the silica aerogel, and the infrared ray shielding particles are dispersed in the silica aerogel.

4. The heat insulating sheet according to claim 1, wherein the infrared ray shielding particles include silicon carbide particles.
